(19) United States
(12) Patent Application Publication
(10) Pub. No.: US 2025/0341604 A1
(43) Pub. Date: Nov. 6, 2025

(54) COMPRESSIVE SENSING CORRELATION INTERFEROMETER DIRECTION FINDING

(71) Applicant: BAE Systems Information and Electronic Systems Integration Inc., Nashua, NH (US)

(72) Inventor: Kyungjung C. Kim, Lexington, MA (US)

(73) Assignee: BAE Systems Information and Electronic Systems Integration Inc., Nashua, NH (US)

(21) Appl. No.: 18/654,401

(22) Filed: May 3, 2024

(51) Int. Cl. G01S 3/06; G01S 3/02; G01S 3/20

(52) U.S. Cl. CPC G01S 3/06; G01S 3/023; G01S 3/20

(57) ABSTRACT

A system and method of detecting a plurality of emitters in a single snapshot. The system includes an antenna that is operable to emit a beamwidth to intercept output signals emitted by a plurality of emitters in a search area. The system also includes a processor that is operable with the antenna for receiving the output signals. The system also includes at least one non-transitory machine readable medium that is operable to be accessed by the processor. The system also includes a computer program product that has instructions stored on the at least one non-transitory machine readable medium, wherein when the computer program product is executed by the processor, a process is carried out by the processor for detecting the plurality of emitters inside of the beamwidth of the direction finding antenna in a single snapshot.

### TECHNICAL FIELD

The present disclosure generally relates to direction finding procedures and/or method to finding multiple emitters in a single snapshot and/or at a single time interval.

### BACKGROUND ART

Direction finding system offer capabilities of determining the physical or geographical location of an emitter. In one example, these direction finding systems are operable to determine the physical or geographical location of an emitter based on radio-frequency (RF) energy radiated from the emitter. In today's environment, however, there is also a growing requirement for determining the location of emitters as the mobility of communications equipment increases in various communication markets. In one example, radio monitoring when using direction finding systems may allow for searching of sources of interference and localization of non-authorized transmitters. In this example, determining an emitter's location when using direction finding systems is crucial in the military intelligence arena for various reasons, including detecting activities of potential enemies, gaining information on the enemy's communications order of battle, and other various uses that may be crucial and/or essential in such arena.

With such direction finding systems, these systems are also capable of finding a particular emitter if the antenna or direction finder of the system computes the direction of arrival (DOA) of the emitter. In one particular example, however, conventional direction finding systems are only capable of determining and locating a single emitter in a single snapshot or time frame when viewing the surrounding area for a plurality of emitters. In this example, conventional direction finding systems are merely capable of determining and locating a first emitter at a first snapshot or time interval based on the technology equipped with system. Subsequently, these conventional direction finding systems also merely capable of determining and locating a second emitter that is performed after the first snapshot. With such capabilities, users and operators of such technology may be at a disadvantage and/or at risk when using such conventional direction finding systems for quickly determining and locating multiple emitters in the surrounding areas.

### SUMMARY OF THE INVENTION

In one aspect, an exemplary embodiment of the present disclosure may provide a method for detecting a plurality of emitters inside of a beamwidth of a direction finding antenna in a single snapshot. The method includes steps of: installing a computer program product having instructions on a least one non-transitory machine readable medium and executable by a processor of a direction finding (DF) system that, when executed by the processor, causes a process to be carried out for detecting the plurality of emitters inside of a beamwidth of the direction finding antenna, the instructions of the computer program product comprising: access a set of calibration data of known emitters with a first sampling size; access a set of signal measurements of each emitter of the plurality of emitters identified inside of the beamwidth; scale the set of calibration data from the first sampling size to a second sampling size that is less than the first sampling size by a multiscale ratio; and process each emitter signal emitted by each emitter of the plurality of emitters relative to the set of signal measurements and the set of calibration data with the second sampling size; receiving data corresponding to a radiofrequency signal obtained from the beamwidth of the direction finding antenna upon loading the computer program product; and detecting the plurality of emitters inside of the beamwidth in the single snapshot upon execution of the computer program product.

This exemplary embodiment or another exemplary embodiment may further include that the instruction to scale the set of calibration data from the first sampling size to the second sampling size further comprises: down-sample a first set of data relative to the set of calibration data of emitters loaded into the computer program product and the set of signal measurements detected inside of the beamwidth. This exemplary embodiment or another exemplary embodiment may further include that the instruction to scale the set of calibration data from the first sampling size to the second sampling size further comprises: up-sample the first set of data to a second set of data, wherein the second set of data is a subset of the first set of data. This exemplary embodiment or another exemplary embodiment may further include that the instruction to up-sample is accomplished with correlation interferometer direction finding (CIDF) process. This exemplary embodiment or another exemplary embodiment may further include that the instruction to scale the set of calibration data from the first sampling size to the second sampling size further includes that the scale is based on a scaling equation expressed:

O(K/m*n)+O(S³)

wherein the set of calibration data having the second sampling size is represented by (K) and (n) as a number of rows and columns for a matrix, the multiscale ratio is represented by (m), and the calibration data having the second sampling size is represented by(S). This exemplary embodiment or another exemplary embodiment may further include that the instruction to scale the calibration data having the first sampling size is based on a scaling equation expressed:

(K*g)+O(g³)

is represented by (K) and (g) as a number of rows and columns of a calibration matrix. This exemplary embodiment or another exemplary embodiment may further include that the instruction to scale the set of calibration data from the first sampling size to the second sampling size further includes that a selected subset of calibration data is computed from a pre-filtering process accomplished with correlation interferometer direction finding (CIDF) process. This exemplary embodiment or another exemplary embodiment may further include that the step of installing the computer program product further comprises: post-process the plurality of emitters with a corresponding direction of antenna for each emitter of the plurality of emitters; and report the plurality of emitters with the corresponding direction of antenna of each emitter of the plurality of emitters. This exemplary embodiment or another exemplary embodiment may further include that the process is capable of finding one or more emitters having multiple coherent signals.

In another aspect, an exemplary embodiment of the present disclosure may provide a computer program product having instructions on a least one non-transitory machine readable medium and executable by a processor of direction finding (DF) system that, when executed by the processor, causes a process to be carried out for detecting the plurality of emitters inside of a beamwidth of the direction finding antenna. The instructions of the computer program product include: access a set of calibration data of known emitters with a first sampling size; access a set of signal measurements of each emitter of the plurality of emitters identified inside of the beamwidth; scale the set of calibration data from the first sampling size to a second sampling size that is less than the first sampling size by a multiscale ratio; and process each emitter signal emitted by each emitter of the plurality of emitters relative to the set of signal measurements and the set of calibration data with the second sampling size.

This exemplary embodiment or another exemplary embodiment may further include that the instruction to scale the set of calibration data from the first sampling size to the second sampling size further comprises: down-sample a first set of data relative to the set of calibration data of emitters loaded into the computer program product and a set of signal measurements detected inside of the beamwidth. This exemplary embodiment or another exemplary embodiment may further include that the instruction to scale the set of calibration data from the first sampling size to the second sampling size further comprises: up-sample the first set of data to a second set of data, wherein the second set of data is a subset of the first set of data. This exemplary embodiment or another exemplary embodiment may further include that the instruction to up-sample is accomplished with correlation interferometer direction finding (CIDF) process. This exemplary embodiment or another exemplary embodiment may further include that the instruction to scale the set of calibration data from the first sampling size to the second sampling size further includes that the scale is based on a scaling equation expressed:

O(K/m*n)+O(S³)

wherein the set of calibration data having the second sampling size is represented by (K) and (n) as a number of rows and columns for a matrix, the multiscale ratio is represented by (m), and the calibration data having the second sampling size is represented by(S). This exemplary embodiment or another exemplary embodiment may further include that the instruction to scale the calibration data having the first sampling size is based on a scaling equation expressed:

(K*g)+O(g³)

is represented by (K) and (g) as a number of rows and columns of a calibration matrix. This exemplary embodiment or another exemplary embodiment may further include that the instruction to scale the set of calibration data from the first sampling size to the second sampling size further includes that a selected subset of calibration data is computed from a pre-filtering process accomplished with correlation interferometer direction finding (CIDF) process. This exemplary embodiment or another exemplary embodiment may further include post-process the plurality of emitters with a corresponding direction of antenna for each emitter of the plurality of emitters; and report the plurality of emitters with the corresponding direction of antenna of each emitter of the plurality of emitters. This exemplary embodiment or another exemplary embodiment may further include that the process is capable of finding one or more emitters having multiple coherent signals.

In yet another aspect, an exemplary embodiment of the present disclosure may provide a system. The system includes an antenna that is operable to emit a beamwidth to intercept output signals emitted by a plurality of emitters in a search area; a processor operable with the antenna for receiving the output signals; at least one non-transitory machine readable medium operable to be accessed by the processor; and a computer program product having instructions stored on the at least one non-transitory machine readable medium, wherein when the computer program product is executed by the processor, a process is carried out by the processor for detecting the plurality of emitters inside of the beamwidth of the direction finding antenna in a single snapshot.

In yet another aspect, an exemplary embodiment of the present disclosure may provide a system. The system includes an antenna that is operable to emit a beamwidth to intercept output signals emitted by a plurality of emitters in a search area; a processor operable with the antenna for receiving the output signals; at least one non-transitory machine readable medium operable to be accessed by the processor; and a computer program product having instructions stored on the at least one non-transitory machine readable medium, wherein when the computer program product is executed by the processor, a process is carried out by the processor for detecting the plurality of emitters inside of the beamwidth of the direction finding antenna in a single snapshot. The instructions of the computer program product of the system also include: access a set of calibration data of known emitters with a first sampling size; access a set of signal measurements of each emitter of the plurality of emitters identified inside of the beamwidth; scale the set of calibration data from the first sampling size to a second sampling size that is less than the first sampling size by a multiscale ratio; and process each emitter signal emitted by each emitter of the plurality of emitters relative to the set of signal measurements and the set of calibration data with the second sampling size.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1A (FIG. 1A) is a PRIOR ART directional finding (DF) system, wherein an antenna of the PRIOR ART DF system finds a first emitter in the surrounding area in a first snapshot.

FIG. 1B (FIG. 1B) is similar to FIG. 1A, but the antenna of the PRIOR ART DF system finds a second emitter in the surrounding area in a second snapshot subsequent to the first snapshot.

FIG. 2 (FIG. 2) is a DF system in accordance with one aspect of the present disclosure, wherein an antenna of the DF system finds multiple emitters in the surrounding area in a single snapshot.

FIG. 3 (FIG. 3) is a diagrammatic view of the DF system illustrated in FIG. 2.

FIG. 4 (FIG. 4) is a block diagram of a DF program equipped to the DF system.

FIG. 5 (FIG. 5) is a graph of a first set of results when using the PRIOR ART DF system and a second set of results when using DF system for detecting emitters in a search area.

FIG. 6 (FIG. 6) is a flowchart of a method in accordance with one aspect of the present disclosure.

Similar numbers refer to similar parts throughout the drawings.

### DETAILED DESCRIPTION

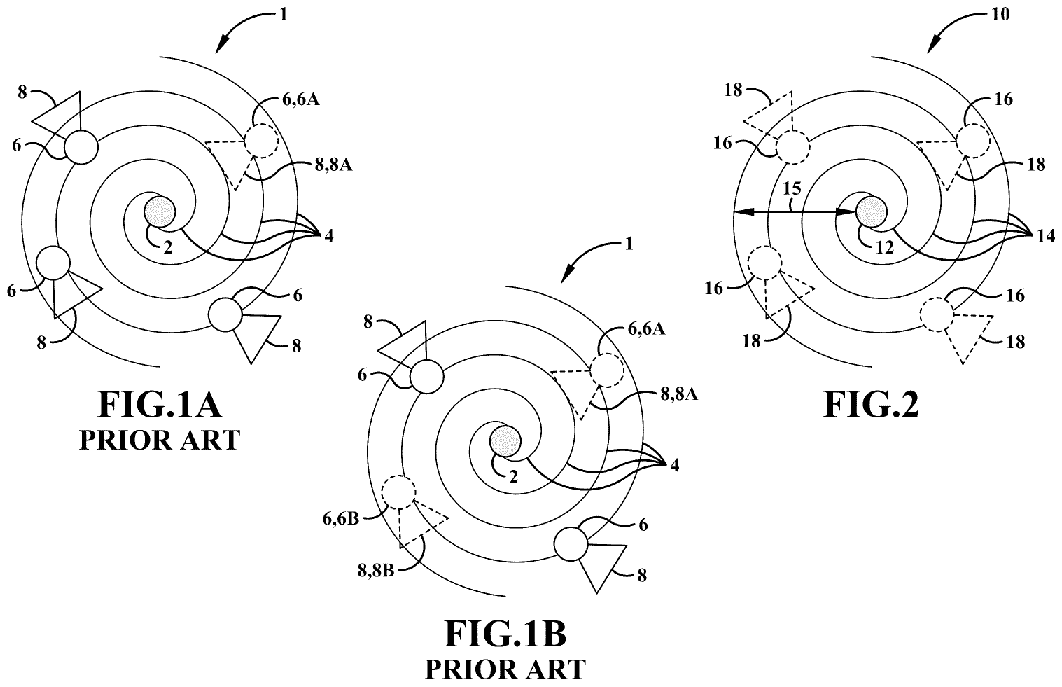

As depicted in FIG. 1, PRIOR ART system 1 includes at least one direction finder or radio antenna 2 that is configured to emit and/or output a beam 4 for receiving and/or intercepting output signals 8 of one or more emitter or radio transmitters of a plurality of emitters or radio transmitters 6 located within the beam 4. It should be noted that beam 4 is also defined by a beamwidth or angle based on the receiving and/or intercepting capabilities of the antenna 2 of system 1.

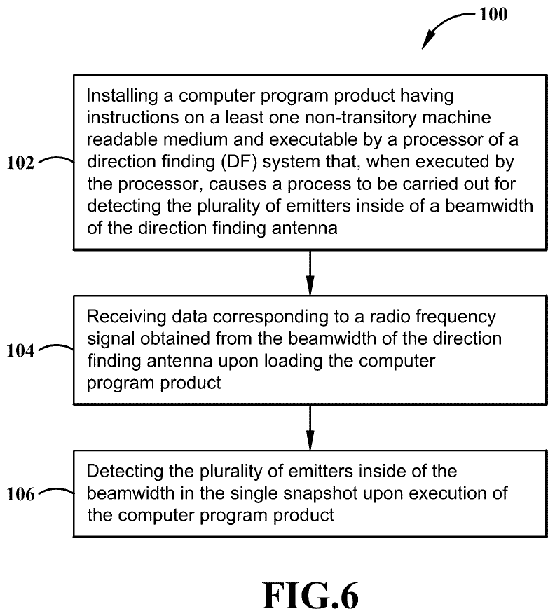

In this PRIOR ART system 1, however, system 1 or conventional systems of like are only capable of determining and locating a single emitter in a single snapshot or time frame when viewing the surrounding area for a plurality of emitters 6. As best seen in FIG. 1A, the system 1 is merely capable of determining and locating a first emitter 6A of the plurality of emitters 6 emitting a first output signal 8A at a first snapshot or time interval based on the technology equipped with system 1; such first emitter 6A emitting the first output signal 8A is shown in dashed lines. Subsequently, the system 1 is also merely capable of determining and locating a second emitter 6B of the plurality of emitters 6 emitting a second output signal 8B at a second snapshot or time interval (see FIG. 1B) that is performed after the first snapshot shown in FIG. 6A; such second emitter 6B emitting the second output signal 8B is shown in dashed lines. With such capabilities, users and operators of such technology may be at a disadvantage and/or at risk when using PRIOR ART system 1 for quickly determining and locating multiple emitters in the surrounding areas.

FIG. 2 illustrates a directional antenna finding system or radio directional finding system that is generally referred to herein as 10; for brevity, the directional antenna finding system will be referred to as system 10 throughout the present disclosure.

As best seen in FIG. 2, system 10 includes at least one direction finder, radio antenna, or direction finding antenna 12 that is configured to emit and/or output a beam 14 for receiving and/or intercepting output signals 18 of one or more emitter or radio transmitters of a plurality of emitters or radio transmitters 16 located within the beam 14. It should be noted that beam 14 is also defined by a beamwidth or angle 15 based on the receiving and/or intercepting capabilities of the antenna 12 of system 10. As described in greater detail below, system 10 is configured to scan and find at least two emitters of the plurality of emitters 16 in a single snapshot as compared to the PRIOR ART antenna system 1 shown in FIGS. 1A-1B performing such operation in at least two snapshots.

It should be noted that antenna 12 may be any suitable device or component that is capable of finding the direction or bearing of at least two emitters or radio transmitters 16 in a single snapshot or at a single time interval. In one exemplary embodiment, and as best seen in FIG. 2, antenna 12 is shown as a spiral antenna capable of outputting a beam 14 at a concentrated beamwidth 15 for finding the direction or bearing of at least two emitters or radio transmitters 16 based on the output signal 18 intercepted by the antenna 12. In another exemplary embodiment, a direction finder may be capable of outputting defined beam patterns or beamwidths dictated by the implementation of the direction finder to find the direction or bearing of at least two emitters or radio transmitters in a single snapshot or at a single time interval.

It should be understood that any suitable antenna or antenna 12 may be used to estimate and determine the number of emitters 16 as well as a corresponding direction of arrival (DOA) in a single snapshot, which is discussed in greater detail below. In one example, and as best seen in FIG. 2, antenna or antenna 12 of system 10 is a spiral antenna that is used to receive and/or intercept one or more radio signals output by emitters 16. In other examples, any suitable antenna may be used in system 10 discussed herein to receive and/or intercept one or more radio signals outputted by emitters 16 that is then used to estimate and determine the number of emitters 16 as well as a corresponding direction of arrival (DOA) in a single snapshot. Examples of other suitable antennas for system 10 include, but are not limited to, directional antennas, omnidirectional antennas, horn antennas, and other suitable antennas that may receive and/or intercept one or more radio signals outputted by emitters 16 that is then used to estimate and determine the number of emitters 16 as well as a corresponding direction of arrival (DOA) in a single snapshot.

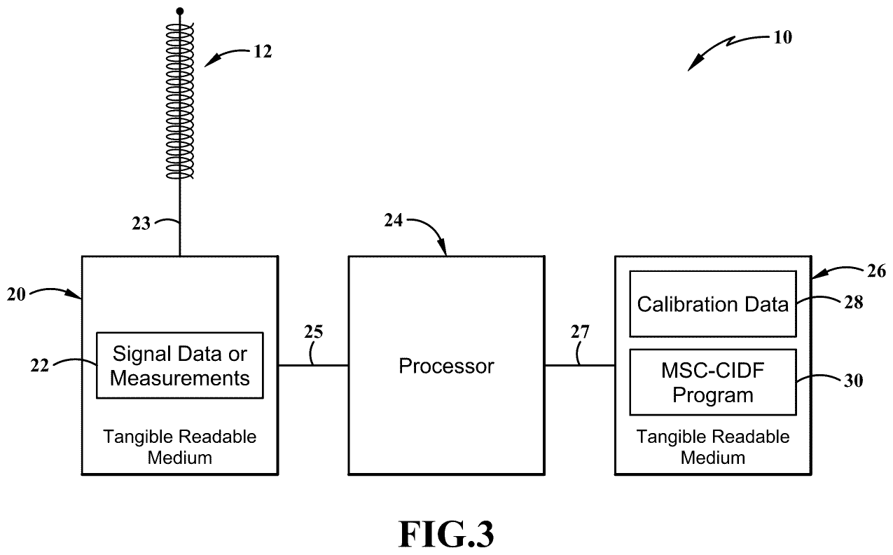

System 10 includes a first non-transitory tangible readable medium or computer readable medium that is generally referred to as 20 and is operable with the antenna 12. As best seen in FIG. 3, the first computer readable medium 20 is configured to receive and save signal data or measurements 22 transmitted from and collected by the antenna 12; such reception of signal data 22 is denoted diagrammatically by a line labeled 23 in FIG. 3 as being an output or electrical connection. In the present disclosure, the signal data 22 transmitted from the antenna 12 includes radio signals 18 outputted by one or more emitters of the plurality of emitters 16 that are visible and intercepted by the antenna 12. It should be noted that such signal data 22 collected by the antenna 12 may be updated and increased with new signal data upon each snapshot taken by the antenna 12 in operation. Such use of signal data 22 is discussed in greater detail below.

System 10 also includes a processor that is generally referred to as 24 and is operable with the first computer readable medium 20. As best seen in FIG. 3, processor 24 is operable to access and use the signal data 22 saved to the first computer readable medium 20; such access of signal data 22 by the processor 24 is denoted diagrammatically by a line labeled 25 in FIG. 3 as being an output or electrical connection. Such use and purpose of the signal data 22 by the processor 24 is discussed in greater detail below.

Processor 24 may be a computer, a processor, a logic, a logic controller, a series of logics, or the like which may include or be in further communication with one or more non-transitory storage mediums and may be operable to both in code and/or carry out a set of encoded instructions contained thereon. Processor 24 may control system 10, including antenna 12, to dictate or otherwise oversee the operations thereof as discussed further herein. Processor 24 may be in further communications with other systems or processor such as other computers or systems carried alongside or along with system 10 as discussed further below. According to one non-limiting example, where system 10 is carried by a vehicle or platform, processor 24 may be in further communication with other systems on the vehicle or platform such as onboard directional antenna finding components.

System 10 includes a second non-transitory tangible readable medium or computer readable medium that is generally referred to as 26 and is operable with the antenna 12. As best seen in FIG. 3, the second computer readable medium 26 is configured to be loaded with calibration data 28 that includes known data, parameters, and information relating to known emitters that may be intercepted by system 10; such calibration data 28 is also discussed in greater detail below. In operation, processor 24 is operable to access and use the calibration data 28 that is stored on the second computer readable medium 26; such access of calibration data 28 by processor 24 is denoted diagrammatically by a line labeled 27 in FIG. 3 as being an output or electrical connection.

Still referring to FIG. 3, the second computer readable medium 26 is also configured to be loaded with multi-scale compressive sending correlation interferometer direction finding (MCS-CIDF) computer program product or computer-implemented product that is generally referred to as 30; for brevity, MCS-CIDF computer program product 30 will be referred to as direction finding (DF) program 30. In operation, processor 24 is operable to access and execute the DF program 30 that is stored on the second computer readable medium 26; such access and execution of DF program 30 by processor 24 is denoted diagrammatically by the line labeled 27 in FIG. 3 as being an output or electrical connection. As discussed in greater detail below, the DF program 30 commands and/or causes the processor 24, upon execution, to find and report one or more directions of antennas of the emitters 16 intercepted by the antenna 12 at a single snapshot and/or at a single time interval.

It should be understood that while system 10 includes first computer readable medium 20 and second computer readable medium 26, any suitable configuration of system 10 may be provided. In one exemplary embodiment, system 10 may include a single computer readable medium that is configured to store signal data or measurements 22 transmitted from the antenna 12. In this exemplary embodiment, calibration data 28 and DF program 30 may also be stored on the single computer readable medium in which the processor 24 may access and execute for finding emitters 16 based on the processing of the signal data 22 and the calibration data 28 performed by the processor 24 when executing the DF program 30.

With respect to DF program 30, DF program 30 includes a set of instructions and/or steps that is executed by processor 24 to report the number of emitters 16 and a corresponding direction of arrival (or DOAs) 18 for each detected emitter.

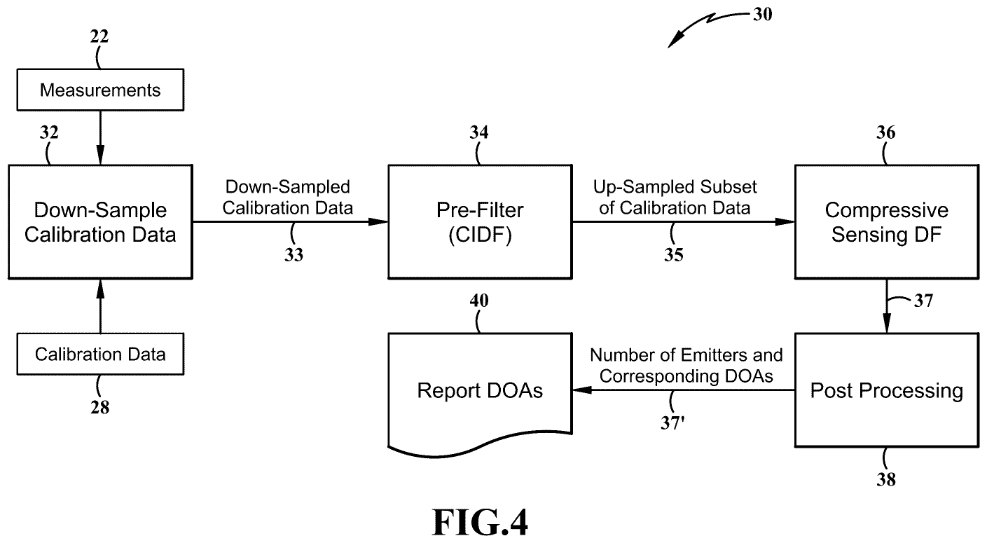

FIG. 4 depicts that DF program 30 includes a first step or down-sampling step 32 that is initially accessed and executed by the processor 24. Upon such execution, processor 24 is commanded to access the signal data and/or measurements 22 from the first computer readable medium 20. As stated above, the signal data 22 is the output signals 18 of the plurality of the emitters 16 intercepted by the antenna 12 at a single snapshot and/or at a single time interval. Concurrently, processor 24 is also commanded to access calibration data 28 that is preloaded into second computer readable medium 26 of system 10. As stated previously, calibration data 28 includes known data, parameters, and information relating to known emitters that may be intercepted by system 10.

Upon such access of emitter measurements 22 and calibration data 28, processor 24 is commanded to perform a down-sampling process based on calibration data 28. In step 32, processor 24 generates a down-sampled or compressed calibration data based on the original and/or complete set of calibration data 28 initially loaded into system 10; such down-sampled calibration data is denoted diagrammatically as an arrow labeled 33 in FIG. 4. In this step, the down-sampled calibration data includes a second sampling size that is less than a first sampling size of the set of calibration data 28 originally loaded into system 10. It should be understood that any suitable methods and/or procedures of down-sampling or compression may be used in this step 32.

DF program 30 also includes a second step or pre-filter step 34 that is accessed and executed by the processor 24 subsequent to step 32. Upon such execution, processor 24 is commanded to perform operations of up-sampling a subset of calibration data taken from the down-sampled calibration data 31 performed in step 32; such generation of up-sampled calibration data is denoted diagrammatically as an arrow labeled 35 in FIG. 4. To accomplish step 34, the processor 24 accesses a pre-filter program or process that is preloaded into DF system 30. In this particular embodiment, step 34 of DF system 30 is loaded with a correlation interferometer direction finding (CIDF) process that is used to accomplish and generate the up-sampled calibration data 35. With such access to CIDF procedure, step 34 performed by processor 24 may act as a pre-filter prior to processor 24 generating the number of emitters found in the beamwidth 15 along with corresponding DOAs.

It should be understood that such inclusion of the CIDF process in DF program 30 is considered advantageous at least because the DF program 30 is leveraging and/or utilizing the CIDF process as a pre-filter for finding the emitters 16 intercepted by the antenna 12. Such pre-filtering capabilities of calibration data reduces the computational complexity performed by processor 24 when trying to find said emitters 16 intercepted by the antenna 12. Stated differently, the pre-filtering capabilities of calibration data minimizes the spatial search are of the compressive sensing optimization process, which is discussed in greater detail below, to substantially reduce the computation complexity on a platform that is equipped with system 10.

DF program 30 also includes a third step or compressive sensing direction finding (DF) step 36 that is accessed and executed by the processor 24 subsequent to step 34. Upon such execution, processor 24 is commanded to utilize the emitter measurements 22 accessed at step 32 along with the up-sampled calibration data 35 generated at step 34. At this stage, processor 24 is commanded to find one or more predetermined signals from the up-sampled calibration data 35 that matches with one or more output signals provided in emitter measurements 22 to process and generate the number of emitters 16 found in the beamwidth 15 along with corresponding DOAs of each emitter 16. Such processing performed by processor 24 may reconstruct and/or create the number of emitters 16 found in the beamwidth 15 along with corresponding DOAs of each emitter 16. The data generated by the processor 24 that includes the number of emitters 16 found in the beamwidth 15 along with corresponding DOAs of each emitter 16 is denoted diagrammatically as an arrow labeled 37 in FIG. 4. The computation required of step 36 is discussed in greater detail below.

DF program 30 also includes a fourth step or post-processing step 38 that is accessed and executed by the processor 24 subsequent to step 36. Upon such execution, processor 24 is commanded to organize and arrange the data 37 in a desired style that is included in DF program 30. It should be noted that any post-processing methods and/or procedures may be used to organize and arrange the data 37 into a desired style. The data 37 that is outputted from step 38 is denoted as an arrow labeled 37′ in FIG. 4.

DF program 30 also includes a fifth step or reporting step 40 that is accessed and executed by the processor 24 subsequent to step 38. Upon such execution, processor 24 is commanded to provide a report to an end user or operator that is operable with system 10 based on the data 37 computed and generated by processor 24. Particularly, step 40 provides a report of at least the DOAs for each emitter found inside of the beamwidth 15 at a single snapshot and/or at a single time interval. It should be noted that additional information may be included in step 40 based on the emitter measurements 22 intercepted by the antenna 12.

Prior to step 34 or accomplishing pre-filtering computations, the following computations may be performed by processor 24:

$$[ \begin{matrix}y ( 0 ) \\ y ( 1 ) \\ ⋮ \\ y ( K )\end{matrix} ] = [ \begin{matrix}{S}_{0} ( 1 ) & {S}_{1} ( 1 ) & … & {S}_{g} ( 1 ) \\ {S}_{0} ( 2 ) & {S}_{1} ( 2 ) & … & {S}_{g} ( 2 ) \\ ⋮ & ⋮ & ⋮ & ⋮ \\ {S}_{0} ( K ) & {S}_{1} ( K ) & … & {S}_{g} ( K )\end{matrix} ] [ \begin{matrix}x ( 0 ) \\ x ( 1 ) \\ ⋮ \\ x ( K ) \\ ⋮ \\ x ( g )\end{matrix} ] \qquad Equation ( 1.1 )$$

$$O ( K * g ) + O ( {g}^{3} ) \qquad Equation ( 1.2 )$$

where, when reading from left to right, the first matrix is a set of measured voltages taken from emitters 16 intercepted by the antenna 12, the second matrix is a sampling matrix (or calibration matrix), and the third matrix is the input signal of Equation 1.2. It should be noted that in Equations 1.1 and 1.2 the variable S is the number of columns of calibration data prior to the pre-filtering step 34 that uses CIDF, and variables K and g are number of columns and rows of the calibration data, and variable g is the number of columns of the original calibration matrix before pre-filtering.

As discussed previously, step 36 or compressive sensing DF includes computations that are performed by processor 24 in order to generate the number of emitters 16 found in the beamwidth 15 along with corresponding DOAs of each emitter at a single snapshot. The following computations are performed by processor 24 in step 36.

In step 36, the compressive sensing DF process includes the understanding of the Nyquist-Shannon sampling theorem:

$${F}_{s} > 2 B \qquad Equation ( 1.3 )$$

where variable F_{S} is the sampling rate and variable B in the highest frequency in Equation 1.3. Under certain conditions with respect to the compressive sensing DF process of step 36 included in DF program 30, the compressive sensing DF process compresses and/or lessens sampling under the Nyquist-Shannon condition (e.g., a sub-Nyquist rate). By having the advantage of sampling at a lesser rate, the storage and bandwidth required in system 10 is less as compared to other methods and procedures currently used in the art, specifically PRIOR ART system 1.

In step 36, compressive sensing conditions are also included based on the utilization of the following underdetermined linear systems:

$$[ \begin{matrix}y ( 0 ) \\ y ( 1 ) \\ ⋮ \\ y ( K )\end{matrix} ] = [ \begin{matrix}{S}_{0} ( 1 ) & {S}_{1} ( 1 ) & … & {S}_{n} ( 1 ) \\ {S}_{0} ( 2 ) & {S}_{1} ( 2 ) & … & {S}_{n} ( 2 ) \\ ⋮ & ⋮ & ⋮ & ⋮ \\ {S}_{0} ( K ) & {S}_{1} ( K ) & … & {S}_{n} ( K )\end{matrix} ] [ \begin{matrix}x ( 0 ) \\ x ( 1 ) \\ ⋮ \\ x ( K ) \\ ⋮ \\ x ( n )\end{matrix} ] \qquad Equation ( 1.4 )$$

$$K << n \qquad Equation ( 1.5 )$$

where, when reading from left to right, the first matrix is a set of measured voltages taken from emitters 16 intercepted by the antenna 12, the second matrix is a sampling matrix (or calibration matrix), and the third matrix is the input signal of Equation 1.4. It should be noted that variable m (g/n) is the multiscale ratio used in compressive sensing DF, the variable S is the number of columns of selected subset from the pre-filtering step 34 using CIDF, and variables K and n are number of columns and rows of the pre-filtered calibration data. It should also be noted that only p elements are non-zero while the other elements are zero, and any 2*p columns of the sampling matrix are independent. Additionally, as cited in Equation 1.5, the value size of n must be substantially greater than the value size of m in this computation.

Continuing from Equation 1.4, step 36 may further include the following computation based on the connection between the compressive sensing and direction finding systems:

$$[ \begin{matrix}y ( 0 ) \\ y ( 1 ) \\ ⋮ \\ ⋮ \\ y ( 8 )\end{matrix} ] = {a [ 1 exp ( i \frac{2 π}{λ} d cos θ ) … exp ( i \frac{2 π}{λ} 7 d cos θ ) ]}^{T} + w = {a [ {S}_{1} ]}^{T} \qquad Equation ( 1.6 )$$

which may be converted to:

$$[ \begin{matrix}y ( 0 ) \\ y ( 1 ) \\ ⋮ \\ ⋮ \\ y ( 8 )\end{matrix} ] = [ \begin{matrix}{S}_{0} ( 1 ) & {S}_{1} ( 1 ) & … & {S}_{360} ( 1 ) \\ {S}_{0} ( 2 ) & {S}_{1} ( 2 ) & … & {S}_{360} ( 1 ) \\ ⋮ & ⋮ & & ⋮ \\ ⋮ & ⋮ & & ⋮ \\ {S}_{0} ( 8 ) & {S}_{1} ( 2 ) & … & {S}_{360} ( 1 )\end{matrix} ] [ \begin{matrix}0 \\ a \\ 0 \\ 0 \\ 0 \\ 0 \\ 0 \\ 0 \\ 0 \\ ⋮ \\ 0\end{matrix} ] \qquad Equation ( 1.7 )$$

where, when reading from left to right, the first matrix is a set of measured voltages taken from emitters 16 intercepted by the antenna 12, the second matrix is a calibration matrix, and the third matrix is the input signal or sparse vector of Equation 1.7. In the sparse vector, the variable a positioned in the second row signifies the location of a direction of arrival or DOA from an emitter. It should be noted that Equation 1.7 follows the Brute-Force Technique (also known as the Greedy Algorithm).

Continuing with this computation, step 36 may also include quadratic programming (as shown below) that continues from Equation 1.7:

$$[ \begin{matrix}y ( 0 ) \\ y ( 1 ) \\ ⋮ \\ ⋮ \\ y ( 8 )\end{matrix} ] = [ \begin{matrix}{S}_{0} ( 1 ) & {S}_{1} ( 1 ) & … & {S}_{360} ( 1 ) \\ {S}_{0} ( 2 ) & {S}_{1} ( 2 ) & … & {S}_{360} ( 1 ) \\ ⋮ & ⋮ & & ⋮ \\ ⋮ & ⋮ & & ⋮ \\ {S}_{0} ( 8 ) & {S}_{1} ( 2 ) & … & {S}_{360} ( 1 )\end{matrix} ] [ \begin{matrix}0 \\ 1 \\ 0 \\ 0 \\ 0 \\ 0 \\ 0 \\ 0 \\ 0 \\ ⋮ \\ 0\end{matrix} ] + [ \begin{matrix}n ( 0 ) \\ n ( 1 ) \\ ⋮ \\ ⋮ \\ ⋮ \\ ⋮ \\ ⋮ \\ ⋮ \\ ⋮ \\ n ( 360 )\end{matrix} ] \qquad Equation ( 1.8 )$$

With such computation, mutual coupling and near field scatter may decrease the coherence between steering vectors in the calibration data (i.e., the second matrix). Additionally, the restricted isometry property (RIP) condition may also be utilized in step 36 with the following equations for low coherence:

$$\frac{{‖ Sx ‖}^{2} - {‖ x ‖}^{2}}{{‖ x ‖}^{2}} < ε \qquad Equation ( 1.9 )$$

$$ε < \frac{1}{\sqrt{2} + 1} \approx 0.4 \qquad Equation ( 1.1 )$$

Further, step 36 may also include LASSO or basic pursuit computations that relate with the quadric programming (Equation 1.8):

$${min}_{x} γ {‖ x ‖}_{1} + \frac{1}{2} {‖ y - Sx ‖}_{2}^{2} \qquad Equation ( 1.11 )$$

where/1 minimization (L1) is recognized, and a constraint on Equation 1.11 is convex optimization provided with the quadric programming (see Equation 1.8).

With respect to compressive sensing parameters, step 36 may also include regularization parameters (RP) based on the complexity of signal noise. For this specific DF program 30, RP is determined by the magnitude of a CIDF correlation coefficient; such equation relating to RP is shown below:

$$min {‖ y - Gx ‖}_{2}^{2} + λ {‖ x ‖}_{1} \qquad Equation ( 1.12 )$$

wherein the variable λ is the regularization parameter in step 36.

In all, the computational complexity provided with step 36 is shown in the following equation:

$$O ( K / m * n ) + O ( {S}^{3} ) \qquad Equation ( 1.13 )$$

wherein variables n and K are the number of columns and rows of the calibration matrix, the variable m (g/n) is the multiscale ratio, and S is the number of columns of selected subset from the pre-filtering step using CIDF. In one exemplary embodiment, and as shown in Equations 1.7 and 1.8, the value used for n was eight antennas and the value used for n was 360 (only for azimuth).

Such computations performed in step 36 is based on a single snapshot measurement or measurement taken at a single iteration to measure emitters 16 located with a given search area. Such computations performed in step 36 are considered advantageous at least because the DF program 30 avoids computing a sampling covariance matrix, which requires a vast number of samples measured under a non-stationary noise environment.

The inclusion of DF program 30 into system 10 is also considered advantageous due to such system 10 being capable of handling multiple emitters at once as well as handling multiple coherent signals or multipath based on the computations and information stated herein.

Having now discussed the system and DF program 30, a method of using system 10 with DF program 30 to estimate a number of emitters with corresponding DOAs in a single snapshot is now discussed in greater detail below.

Upon operation of system 10, antenna 12 is commanded to radiate one or more beams 14 defining beamwidth 15 in a search area that surrounds the antenna 12 (see FIG. 2). It should be noted that while system 10 is shown using a single antenna 12 or antenna, additional direction finders or antennas may also be powered and command to radiate one or more beams 14 defining beamwidth 15 in a search area that surrounds the direction finder. In the present disclosure, antenna 12 radiates a spiral beam 14 with a constant beamwidth 15 for detecting and intercepting one or more emitters of a plurality of emitters 16 surrounding said antenna 12 in said search area.

Once the antenna 12 receives and intercepts output signals 18 emitted from plurality of emitters 16, the antenna 12 transmits such output signals 18 to the first computer readable medium 20 to establish such signals as emitter measurements 22. Upon such transmission, processor 24 may access and extract the emitter measurements 22 from the first computer readable medium 20 upon accessing and executing DF program 30. Concurrently, processor 24 may also access and extract calibration data 28 that is loaded into the second computer readable medium 26 upon accessing and executing DF program 30. Once the emitter measurements 22 and calibration data 28 are each extracted by processor 24, processor 24 is caused to then execute the DF program 30 to find the number of emitters 16 along with corresponding DOAs based on emitter measurements 22 and calibration data 28.

Initially, processor 24 is commanded to perform a down-sampling process based on calibration data 28 in step 32. In this step, processor 24 generates a down-sampled or compressed calibration data based on the original and/or complete set of calibration data 28 initially loaded into system 10; such down-sampled calibration data is denoted diagrammatically as the arrow labeled 33 in FIG. 4. In this step, the down-sampled calibration data 28 includes a second sampling size which is less than a first sampling size of the set of calibration data 28 originally loaded into system 10. It should be understood that any suitable methods and/or procedures of down-sampling or compression may be used in this step 32.

Processor 24 then proceeds to execute step 34 upon executing step 32. At this stage, processor 24 is commanded to perform operations of up-sampling a subset of calibration data taken from the down-sampled calibration data 31 perform in step 32; such generation of up-sampled calibration data is denoted diagrammatically as the arrow labeled 35 in FIG. 4. To accomplish step 34, the processor 24 accesses pre-filter program or process that is preloaded into DF system 30. In this particular embodiment, step 34 of DF system 30 is loaded with CIDF process that is used to accomplish and generate the up-sampled calibration data 35. As such, step 34 performed by processor 24 may act as a pre-filter prior to processor 24 generating the number of emitters found in the beamwidth 15 along with corresponding DOAs.

Processor 24 then proceeds to execute step 36 upon executing steps 32 and 34. At this stage, processor 24 is commanded to utilize the emitter measurements 22 accessed at step 32 along with the up-sampled calibration data 35 generated at step 34. Processor 24 is commanded to find one or more predetermined signals from the up-sampled calibration data 35 that matches with one or more output signals provided in emitter measurements 22 to process and generate the number of emitters 16 found in the beamwidth 15 along with corresponding DOAs of each emitter 16. Such processing performed by processor 24 may reconstruct and/or create the number of emitters 16 found in the beamwidth 15 along with corresponding DOAs of each emitter 16. The data generated by the processor 24 that includes the number of emitters 16 found in the beamwidth 15 along with corresponding DOAs of each emitter 16 is denoted diagrammatically as an arrow labeled 37 in FIG. 4. The computation required of step 36 is previously discussed above. The emitters 16 (along with the corresponding DOAs) that are detected by DF program 30 in a single snapshot are shown in dashed lines in FIG. 2 for illustrative purposes.

Processor 24 then proceeds to execute step 38 upon executing step 36. At this stage, processor 24 is configured to organize and arrange the data 37 in a desired style that is included in DF program 30. The data 37 that is outputted from step 38 is denoted as an arrow labeled 37′ in FIG. 4. Processor 24 then proceeds to execute step 40 upon executing step 38. At this stage, processor 24 is configured to provide a report to an end user or operator that is operable with system 10 based on the data 37 computed and generated by processor 24. Particularly, step 40 provides a report of at least the DOAs for each emitter found inside of the beamwidth 15 at a single snapshot and/or at a single time interval. It should be noted that additional information may be included in step 40 based on the emitter measurements 22 intercepted by the antenna 12.

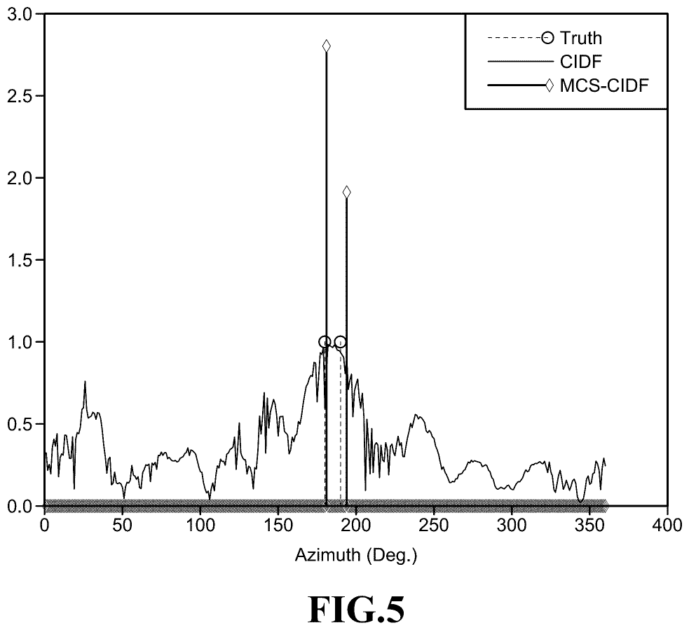

FIG. 5 is a graph that depicts an exemplary simulation of detecting the plurality of emitters in a search area when using conventional DF systems (such as PRIOR ART system 1) and DF system 10 discussed above. In this example, a first emitter has a first DOA of approximately 180 degrees while a second emitter has a second DOA of approximately 189 degrees.

Upon using system 10, system 10 is operable to compute and provide the first and second DOAs of the first and second emitters simultaneously. Based on the results from system 10, system 10 estimated a first DOA of the first emitter at approximately 174 degrees and a second DOA of the second emitter at approximately 194 degrees simultaneously. With such simultaneously results, it has been determined that such results returned a successful detection of both the first DOA of the first emitter and the second DOA of the second emitter. Upon using the PRIOR ART system 1, however, PRIOR ART system 1 fails to estimate the first and second DOAs of the first and second emitters simultaneously located in a search area. Instead, PRIOR ART system 1 only computes a single DOA estimate around a midpoint of the first and second DOAs of the first and second emitters.

FIG. 6 illustrates a flowchart of method 100 for detecting a plurality of emitters inside of a beamwidth of a direction finding antenna in a single snapshot. An initial step 102 of method 100 includes installing a computer program product that has instructions on a least one non-transitory machine readable medium and executable by a processor of a direction finding (DF) system that, when executed by the processor, causes a process to be carried out for detecting the plurality of emitters inside of a beamwidth of the direction finding antenna, the instructions of the computer program product comprising: access a set of calibration data of known emitters with a first sampling size; access a set of signal measurements of each emitter of the plurality of emitters identified inside of the beamwidth; scale the set of calibration data from the first sampling size to a second sampling size that is less than the first sampling size by a multiscale ratio; and process each emitter signal emitted by each emitter of the plurality of emitters relative to the set of signal measurements and the set of calibration data with the second sampling size. Another step 104 of method 100 includes receiving data corresponding to a radiofrequency signal obtained from the beamwidth of the direction finding antenna upon loading the computer program product. Another step 106 of method 100 includes detecting the plurality of emitters inside of the beamwidth in the single snapshot upon execution of the computer program product.

In other exemplary embodiments, method 100 may include additional and/or optional steps for detecting a plurality of emitters inside of a beamwidth of a direction finding antenna in a single snapshot. In one exemplary embodiment, method 100 may further include that the instruction to scale the set of calibration data from the first sampling size to the second sampling size further comprises: down-sample a first set of data relative to the set of calibration data of emitters loaded into the computer program product and the set of signal measurements detected inside of the beamwidth. In another exemplary embodiment, method 100 may further include that the instruction to scale the set of calibration data from the first sampling size to the second sampling size further comprises: up-sample the first set of data to a second set of data, wherein the second set of data is a subset of the first set of data. In another exemplary embodiment, method 100 may further include that the instruction to up-sample is accomplished with correlation interferometer direction finding (CIDF) process. In another exemplary embodiment, method 100 may further include that the instruction to scale the set of calibration data from the first sampling size to the second sampling size further includes that the scale is based on a scaling equation expressed:

O(K/m*n)+O(S³)

wherein the set of calibration data having the second sampling size is represented by (K) and (n) as a number of rows and columns for a matrix, the multiscale ratio is represented by (m), and the calibration data having the second sampling size is represented by(S). In another exemplary embodiment, method 100 may further include that the instruction to scale the calibration data having the first sampling size is based on a scaling equation expressed:

(K*g)+O(g³)

is represented by (K) and (g) as a number of rows and columns of a calibration matrix. In another exemplary embodiment, method 100 may further include that the instruction to scale the set of calibration data from the first sampling size to the second sampling size further includes that a selected subset of calibration data is computed from a pre-filtering process accomplished with correlation interferometer direction finding (CIDF) process. In another exemplary embodiment, method 100 may further include post-process the plurality of emitters with a corresponding direction of antenna for each emitter of the plurality of emitters; and report the plurality of emitters with the corresponding direction of antenna of each emitter of the plurality of emitters. In another exemplary embodiment, method 100 may further include that the process is capable of finding one or more emitters having multiple coherent signals.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, firmware or a combination thereof. When implemented in software, the software code or instructions can be executed on any suitable processor or collection of processors, whether provided in a single computer or distributed among multiple computers or in firmware. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of components A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A method for detecting a plurality of emitters inside of a beamwidth of a direction finding antenna in a single snapshot, comprising:
installing a computer program product having instructions on a least one non-transitory machine readable medium and executable by a processor of a direction finding (DF) system that, when executed by the processor, causes a process to be carried out for detecting the plurality of emitters inside of a beamwidth of the direction finding antenna, the instructions of the computer program product comprising:
access a set of calibration data of known emitters with a first sampling size;
access a set of signal measurements of each emitter of the plurality of emitters identified inside of the beamwidth;
scale the set of calibration data from the first sampling size to a second sampling size that is less than the first sampling size by a multiscale ratio; and
process each emitter signal emitted by each emitter of the plurality of emitters relative to the set of signal measurements and the set of calibration data with the second sampling size;
receiving data corresponding to a radiofrequency signal obtained from the beamwidth of the direction finding antenna upon loading the computer program product; and
detecting the plurality of emitters inside of the beamwidth in the single snapshot upon execution of the computer program product.

2. The method of claim 1, wherein the instruction to scale the set of calibration data from the first sampling size to the second sampling size further comprises:
down-sample a first set of data relative to the set of calibration data of emitters loaded into the computer program product and the set of signal measurements detected inside of the beamwidth.

3. The method of claim 2, wherein the instruction to scale the set of calibration data from the first sampling size to the second sampling size further comprises:
up-sample the first set of data to a second set of data, wherein the second set of data is a subset of the first set of data.

4. The method of claim 3, wherein the instruction to up-sample is accomplished with correlation interferometer direction finding (CIDF) process.

5. The method of claim 1, wherein the instruction to scale the set of calibration data from the first sampling size to the second sampling size further includes that the scale is based on a scaling equation expressed:
$$O ( K / m * n ) + O ( {S}^{3} )$$
wherein the set of calibration data having the second sampling size is represented by (K) and (n) as a number of rows and columns for a matrix, the multiscale ratio is represented by (m), and the calibration data having the second sampling size is represented by(S).

6. The method of claim 5, wherein the instruction to scale the calibration data having the first sampling size is based on a scaling equation expressed:
$$( K * g ) + O ( {g}^{3} )$$
is represented by (K) and (g) as a number of rows and columns of a calibration matrix.

7. The method of claim 5, wherein the instruction to scale the set of calibration data from the first sampling size to the second sampling size further includes that a selected subset of calibration data is computed from a pre-filtering process accomplished with correlation interferometer direction finding (CIDF) process.

8. The method of claim 1, further comprising:
post-process the plurality of emitters with a corresponding direction of antenna for each emitter of the plurality of emitters; and
report the plurality of emitters with the corresponding direction of antenna of each emitter of the plurality of emitters.

9. The method of claim 1, further comprising:
finding one or more emitters having multiple coherent signals.

10. A computer program product having instructions on a least one non-transitory machine readable medium and executable by a processor of direction finding (DF) system that, when executed by the processor, causes a process to be carried out for detecting the plurality of emitters inside of a beamwidth of the direction finding antenna, the instructions of the computer program product comprising:
access a set of calibration data of known emitters with a first sampling size;
access a set of signal measurements of each emitter of the plurality of emitters identified inside of the beamwidth;
scale the set of calibration data from the first sampling size to a second sampling size that is less than the first sampling size by a multiscale ratio; and
process each emitter signal emitted by each emitter of the plurality of emitters relative to the set of signal measurements and the set of calibration data with the second sampling size.

11. The computer program product of claim 10, wherein the instruction to scale the set of calibration data from the first sampling size to the second sampling size further comprises:
down-sample a first set of data relative to the set of calibration data of emitters loaded into the computer program product and a set of signal measurements detected inside of the beamwidth.

12. The computer program product of claim 11, wherein the instruction to scale the set of calibration data from the first sampling size to the second sampling size further comprises:
up-sample the first set of data to a second set of data, wherein the second set of data is a subset of the first set of data.

13. The computer program product of claim 12, wherein the instruction to up-sample is accomplished with correlation interferometer direction finding (CIDF) process.

14. The computer program product of claim 10, wherein the instruction to scale the set of calibration data from the first sampling size to the second sampling size further includes that the scale is based on a scaling equation expressed:
$$O ( K / m * n ) + O ( {S}^{3} )$$
wherein the set of calibration data having the second sampling size is represented by (K) and (n) as a number of rows and columns for a matrix, the multiscale ratio is represented by (m), and the calibration data having the second sampling size is represented by(S).

15. The computer program product of claim 14, wherein the instruction to scale the calibration data having the first sampling size is based on a scaling equation expressed:
$$( K * g ) + O ( {g}^{3} )$$
is represented by (K) and (g) as a number of rows and columns of a calibration matrix.

16. The computer program product of claim 14, wherein the instruction to scale the set of calibration data from the first sampling size to the second sampling size further includes that a selected subset of calibration data is computed from a pre-filtering process accomplished with correlation interferometer direction finding (CIDF) process.

17. The computer program product of claim 10, further comprising:
post-process the plurality of emitters with a corresponding direction of antenna for each emitter of the plurality of emitters; and
report the plurality of emitters with the corresponding direction of antenna of each emitter of the plurality of emitters.

18. The computer program product of claim 10, further comprising:
finding one or more emitters having multiple coherent signals.

19. A system, comprising:
an antenna operable to emit a beamwidth to intercept output signals emitted by a plurality of emitters in a search area;
a processor operable with the antenna for receiving the output signals;
at least one non-transitory machine readable medium operable to be accessed by the processor; and
a computer program product having instructions stored on the at least one non-transitory machine readable medium, wherein when the computer program product is executed by the processor, a process is carried out by the processor for detecting the plurality of emitters inside of the beamwidth of the direction finding antenna in a single snapshot.

20. The system of claim 19, wherein the instructions of the computer program product comprise:
access a set of calibration data of known emitters with a first sampling size;
access a set of signal measurements of each emitter of the plurality of emitters identified inside of the beamwidth;
scale the set of calibration data from the first sampling size to a second sampling size that is less than the first sampling size by a multiscale ratio; and
process each emitter signal emitted by each emitter of the plurality of emitters relative to the set of signal measurements and the set of calibration data with the second sampling size.
